(19) United States
(12) Patent Application Publication
(10) Pub. No.: US 2015/0266167 A1
(43) Pub. Date: Sep. 24, 2015

(54) TOOL

(71) Applicant: Glenn Robinson, Parkland, FL (US)

(72) Inventor: Glenn Robinson, Parkland, FL (US)

(21) Appl. No.: 14/544,996

(22) Filed: Mar. 13, 2015

Related U.S. Application Data
(60) Provisional application No. 61/967,386, filed on Mar. 18, 2014.

(51) Int. Cl. B25B 13/14; B25B 13/46

(52) U.S. Cl. CPC B25B 13/14; B25B 13/46

(57) ABSTRACT

The present invention provides for a wrench tool comprising a movable jaw and a plurality of gears including a worm gear, a transmitting gear and an adjustment to move the movable jaw.

### RELATED APPLICATION

This application is related to U.S. Provisional Application Ser. No. 61/967,386 filed on Mar. 18, 2014 entitled “Tool”.

### BACKGROUND OF THE INVENTION

### Field of the Invention

This invention relates to a tool and more specifically, to a wrench with a plurality of gears and at least one movable jaw.

### SUMMARY OF THE INVENTION

In one embodiment, the present invention provides for a tool comprising: an elongated member having opposing ends, a first end comprises a tool head with a bolt engaging member, at least one compartment and at least one channel, and the bolt engaging member comprises at least one fixed jaw and at least one movable jaw, the movable jaw has two opposing ends, a first end of the movable jaw having a contact surface for interacting with the fixed jaw and a second end of the movable jaw comprises a sliding mechanism with a plurality of openings; at least one worm gear comprising a plurality of rotary elements and a protrusion on one end, the rotary elements of the worm gear are designed to engage the openings of the sliding mechanism of the second end of the movable jaw, at least a portion of the worm gear is designed to be situated within the channel of the tool head, and the protrusion of the worm gear is designed to receive at least one transmitting gear; and at least one adjustment gear and at least one transition gear, at least a portion of the adjustment and transition gears are situated within the compartment of the tool head, the adjustment gear is engaged with the transition gear, the transition gear is engaged with the transmitting gear which is engaged with the worm gear and which is further engaged with the sliding mechanism of the movable jaw, whereby the rotation of the adjustment gear creates movement of the movable jaw relative to the fixed jaw.

In another embodiment, the second end of the elongated member comprises a handle. In yet another embodiment, the tool further comprises at least one cavity in the fixed jaw. In still another embodiment, the tool further comprises at least one ratcheting cam, at least a portion of the ratcheting cam is situated within the cavity of the fixed jaw.

In still yet another embodiment, the tool further comprises at least one cavity situated within the movable jaw. In a further embodiment, the tool further comprises at least one ratcheting cam, at least a portion of the ratcheting cam is situated within the cavity of the movable jaw.

In another further embodiment, each of the transmitting gear, the transition gear, and the adjustment gear comprises teeth. In yet a further embodiment, the transmitting gear has at least four teeth. In still a further embodiment, the transition gear has at least four teeth. In still yet a further embodiment, the adjustable gear has at least four teeth.

In another embodiment, there is a 2:1 ratio between the number of the teeth on the adjustment gear and the number of the teeth on the transmitting gear. In another further embodiment, there is a ratio between the number of the teeth on said adjustment gear and the number of the teeth on the transmitting gear, and the ratio is greater than a 1:1.

In yet another further embodiment, the tool further comprises a second compartment, at least a portion of the adjustment gear is situated within the first compartment, at least a portion of the transition gear is situated within the second compartment.

In still yet another further embodiment, each of the adjustment and the transition gears comprise peripheral edges, each of the peripheral edges of the adjustment and the transition gears comprises teeth, and the teeth of the adjustment gears and the teeth of the transition gear engage one another on the on same horizontal plane.

In another embodiment, the adjustment gear comprises at least one surface, the adjustment gear comprise teeth situated on the surface, and the transition comprises two opposing ends, each of the ends having a set of teeth, and the teeth of the adjustment gear and a first set of the teeth of the transition gear engage one another on perpendicular planes.

In yet another embodiment, the transmitting comprises teeth, and the teeth of the transmitting gear and a second set of teeth of the transition gear engage one another on diagonal planes.

In still another embodiment, the present invention relates to a tool comprising: an elongated member having opposing ends, a first end comprises a tool head with a bolt engaging member and at least one channel, the bolt engaging member comprises at least one fixed jaw and at least one movable jaw, said movable jaw having two opposing ends, a first end of the movable jaw having a contact surface for interacting with the fixed jaw and a second end of the movable jaw comprising a sliding mechanism with a plurality of openings; at least one worm gear comprising a plurality of rotary elements and a protrusion on one end, the rotary elements of the worm gear are designed to engage said openings of the sliding mechanism of the second end of the movable jaw, at least a portion of the worm gear is designed to be situated within the channel of the tool head, and the protrusion of the worm gear is designed to receive at least one transmitting gear; and at least one adjustment gear situated within the tool head, and the adjustment gear is engaged with the transmitting gear which is engaged with the worm gear which is further engaged with the sliding mechanism of the movable jaw, whereby rotation of the adjustment gear creates movement of the movable jaw relative to the fixed jaw.

In a further embodiment, the adjustment gear comprises peripheral edges, and the peripheral edges of the adjustment gear comprises teeth, and the transmitting gear comprises a set of teeth, and the teeth of the adjustment gear and the set of teeth of the transmitting gear engage one another on perpendicular planes.

In another further embodiment, the present invention provides for a wrench apparatus comprising: an elongated member having opposing ends, a first end comprises a tool head with a bolt engaging member, the bolt engaging member comprises at least one fixed jaw and at least one movable jaw, the moving jaw having two opposing ends, a first end having a contact surface for interacting with the fixed jaw and a second end comprising a sliding mechanism with a plurality of openings, the second end comprises a handle; at least one worm gear comprising a plurality of rotary elements and a protrusion on one end, the rotary elements of the worm gear are designed to engage the openings of the sliding mechanism of the second end of the movable jaw, the protrusion of the worm gear is designed to receive at least one transmitting gear; and at least one adjustment gear situated within the tool head, the adjustment gear is engaged with the transmitting gear which is engaged with the worm gear which is further engaged with the sliding mechanism of the movable jaw, whereby rotation of the adjustment gear creates movement of the movable jaw relative to said fixed jaw, said adjustment and transmitting gear comprise teeth, wherein there is a 2:1 ratio between the number of the teeth on the adjustment gear and the number of the teeth on the transmitting gear.

In yet another further embodiment, the apparatus further comprises transition gear situated between the adjustment and transmitting gears.

In still another further embodiment, the fixed jaw comprises at least one cavity for receiving a ratcheting device, and the ratcheting device is selected from a group consisting essentially of cams, rollers, sliders, pins, protrusions and combinations thereof.

In still yet another further embodiment, the movable jaw comprises at least one cavity for receiving a ratcheting device, and the ratcheting device is selected from a group consisting essentially of cams, rollers, sliders, pins, protrusions and combinations thereof.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a frontal view of one of the embodiments of the present invention;

FIG. 2 is an exposed view of FIG. 1 showing the internal workings of the gears;

FIG. 3 is an exploded view of FIG. 1;

FIG. 4 is a front view of another embodiment of the present invention;

FIG. 5 is a front view of a further embodiment of the present invention; and

FIG. 6 is an exploded view of FIG. 5.

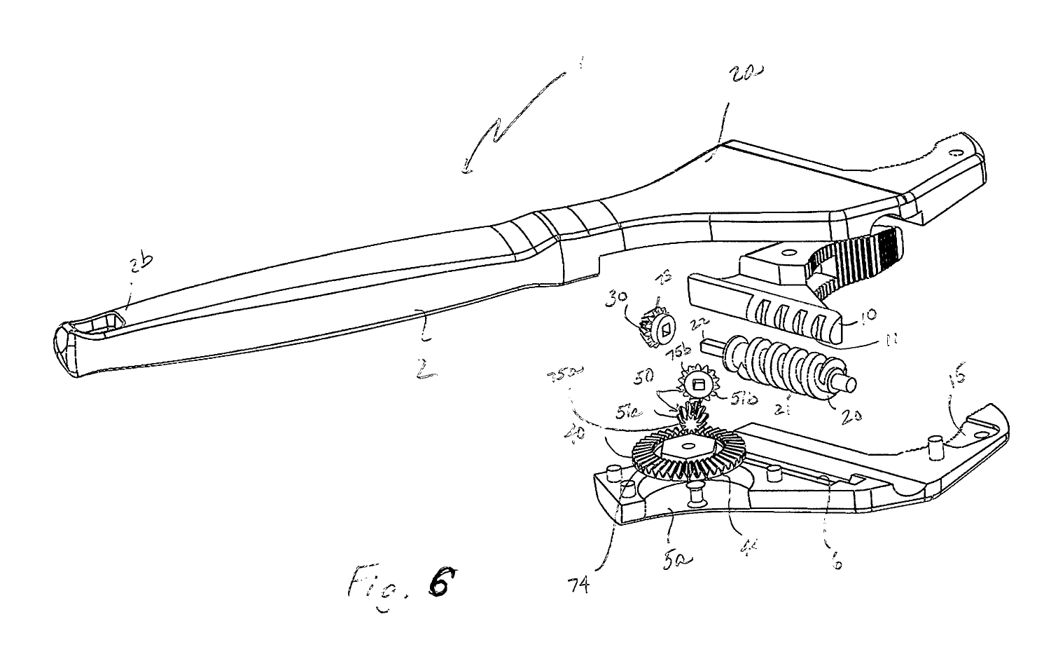

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

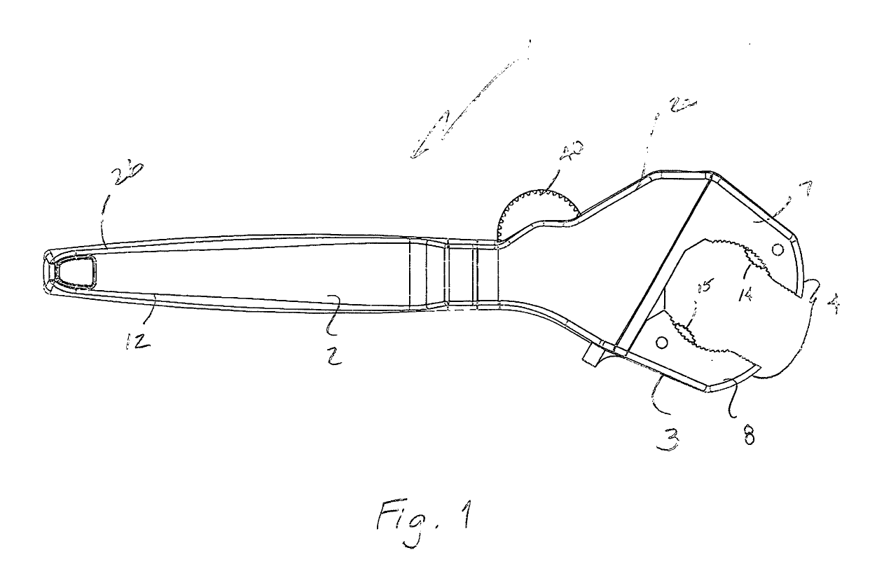

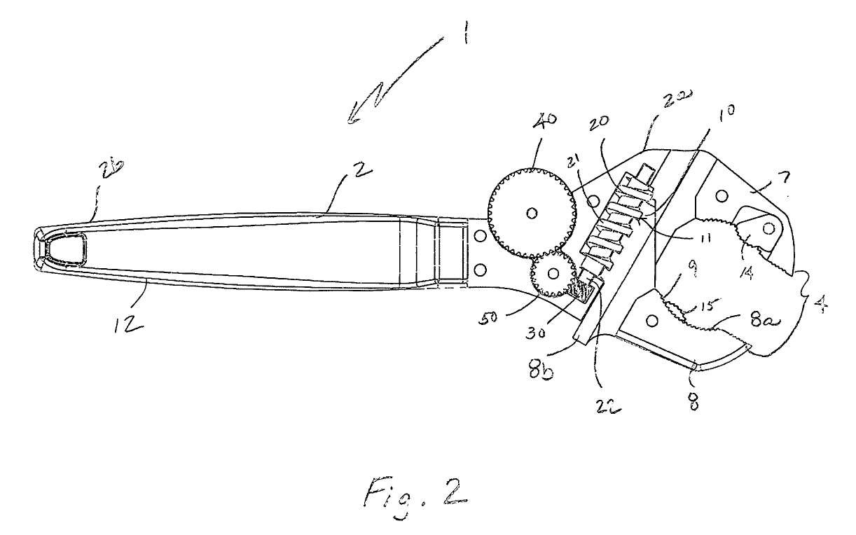

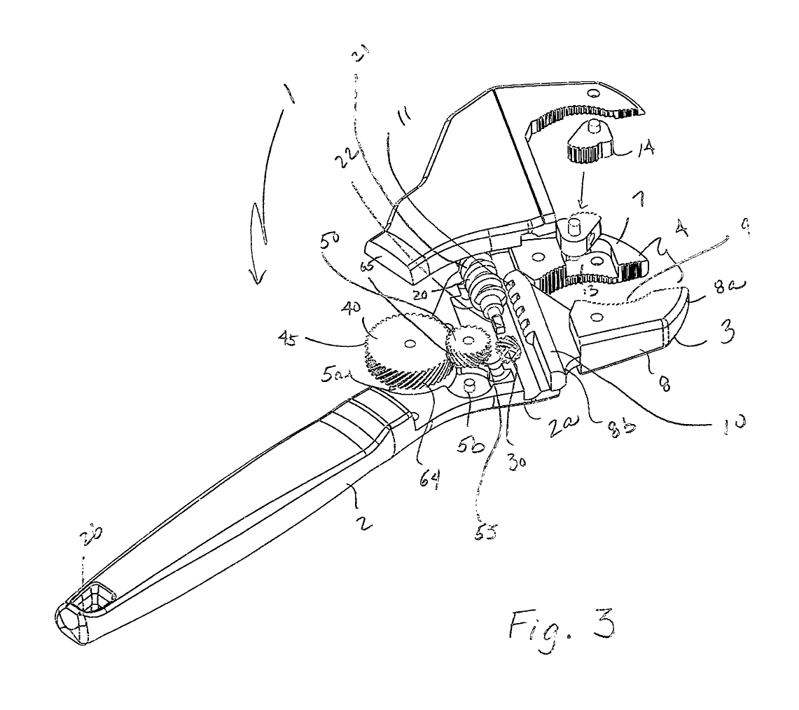

FIGS. 1-3 show one embodiment of the present invention, in particular, a wrench tool 1. The tool 1 comprises: an elongated member 2 having opposing ends, 2a and 2b respectively. The first end 2a comprises a tool head 3 with a bolt engaging member 4, at least one compartment 5a and at least one channel 6. The bolt engaging member 4 comprises at least one fixed jaw 7 and at least one movable jaw 8. The movable jaw 8 has two opposing ends, 8a and 8b respectively. The first end 8a of the movable jaw 8 has a contact surface 9 for interacting with the fixed jaw 7 and a second end 8b of the movable jaw 8 comprises a sliding mechanism 10 with a plurality of openings 11. The tool 1 has at least one worm gear 20 comprising a plurality of rotary elements 21 and a protrusion 22 on one end. The rotary elements 21 of the worm gear 20 are designed to engage the openings 11 of the sliding mechanism 10 of the second end 8b of the movable jaw 8. At least a portion of the worm gear 20 is designed to be situated within the channel 6 of the tool head 3, and the protrusion 22 of the worm gear 20 is designed to receive at least one transmitting gear 30.

The tool 1 further comprises at least one adjustment gear 40 and at least one transition gear 50, and at least a portion of the adjustment gears 40 is situated within the compartment 5a of the tool head 3. The adjustment gear 40 is engaged with the transition gear 50, and the transition gear 50 is engaged with the transmitting gear 30 which is engaged with the worm gear 20 and which is further engaged with the sliding mechanism 10 of the movable jaw 8, whereby the rotation of the adjustment gear 40 creates movement of the movable jaw 8 relative to the fixed jaw 7.

The second end 2b of the elongated member comprises a handle 12. The tool 1 may comprise at least one cavity 13 in the fixed jaw 7. The tool 1 may further comprise at least one ratcheting cam 14, and at least a portion of the ratcheting cam 14 is situated within the cavity 13 of the fixed jaw 7.

The tool 1 may further comprise at least one cavity 15 situated within the movable jaw 8. The tool 1 may further comprise at least one ratcheting cam 16, and at least a portion of the ratcheting cam 16 is situated within the cavity 15 of the movable jaw 8.

Each of the transmitting gear, the adjustment gear, and the transition gear comprises teeth, 63, 64 and 65 respectively. In another embodiment, the tool 1 may further comprise a second compartment 5b, and at least a portion of the adjustment gear 40 is situated within the first compartment 5a, and at least a portion of the transition gear 50 is situated within the second compartment 5b. In a further embodiment, there can be one compartment and at least a portion of the adjustment and transition gears, 40 and 50 respectively are situated in the one compartment.

In a further embodiment, each of the adjustment and the transition gear, 40 and 50 respectively, comprise peripheral edges, 45 and 55 respectively. Each of said peripheral edges, 45 and 55, of the adjustment and the transition gears, 40 and 50 comprises teeth, 64 and 65. The teeth 64 of the adjustment gear 40 and the teeth 65 of the transition gear 50 engage one another on the on same horizontal plane.

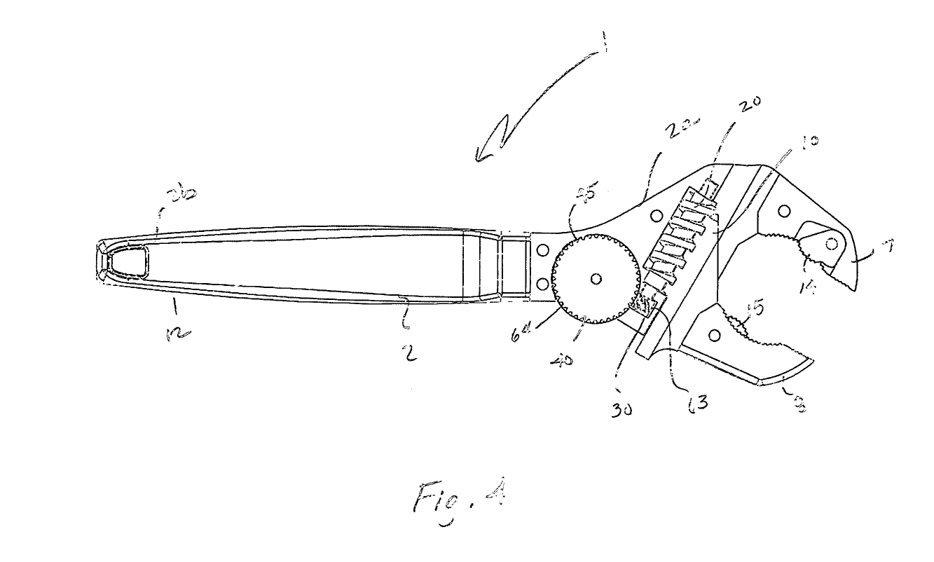

FIG. 4 depicts another embodiment of the present invention wherein there is no transition gear and the adjustment gear 40 is directly engaged with the transmitting gear 30 which is engaged with the worm gear 20 which is further engaged with the sliding mechanism 10 of the movable jaw 8, whereby rotation of the adjustment gear 40 creates movement of the movable jaw 8 relative to the fixed jaw 7.

In yet a further embodiment, the adjustment gear 40 comprises peripheral edges 45, and the peripheral edges 45 of the adjustment gear 40 comprises teeth 64, and the transmitting gear 30 comprises a set of teeth 63, and the teeth 64 of the adjustment gear 40 and the set of teeth 63 of the transmitting gear 30 engage one another on perpendicular planes.

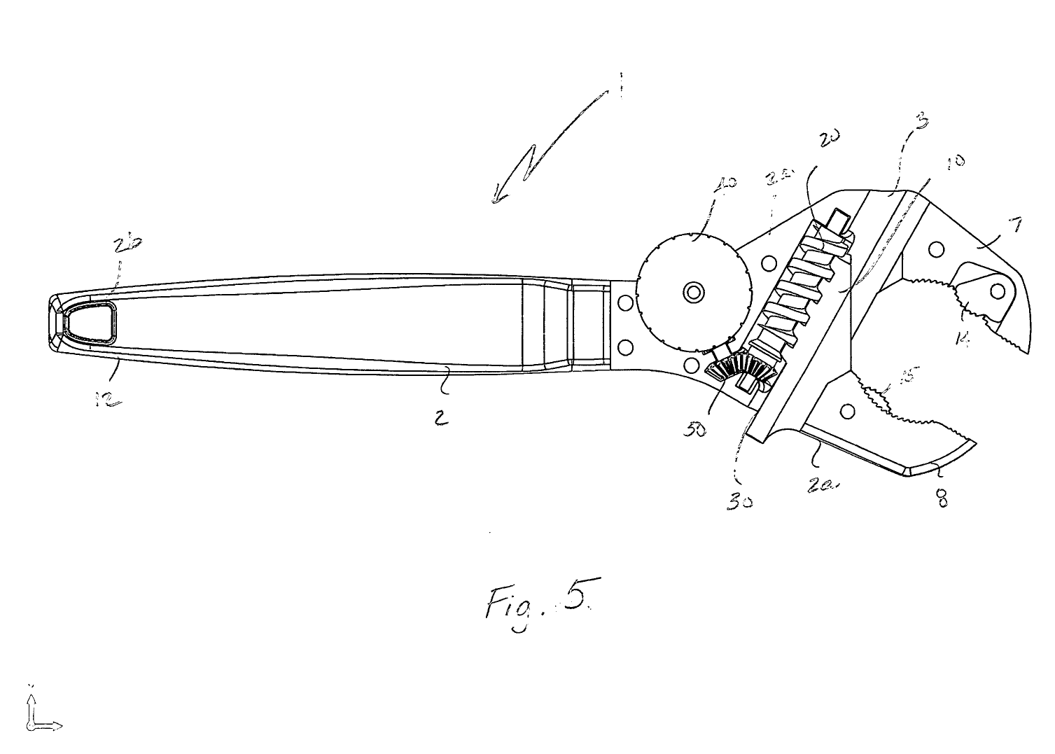

FIG. 5 relates to another further embodiment wherein the tool 1 comprises the transmitting gear 30, the adjustment gear 40, and the transmitting gear 50 but is a different orientation and configuration. In still a further embodiment, the adjustment gear 40 comprises at least one surface 44, and teeth 74 situated on the surface 44. The transition gear 50 comprises two opposing ends, 51a and 51b respectively, and each of the ends having a set of teeth, 75a and 75b. The teeth 74 of the adjustment gear 40 and a first set of the teeth 75a of the transition gear 50 engage one another on perpendicular planes. The transmitting gear 30 comprises teeth 73, and the teeth 73 of the transmitting gear 30 and a second set of teeth 75b of the transition gear 50 engage one another on diagonal planes.

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A tool comprising:
an elongated member having opposing ends, a first end comprises a tool head with a bolt engaging member and at least one channel, said bolt engaging member comprises at least one fixed jaw and at least one movable jaw, said movable jaw having two opposing ends, a first end of said movable jaw having a contact surface for interacting with said fixed jaw and a second end of said movable jaw comprising a sliding mechanism with a plurality of openings;
at least one worm gear comprising a plurality of rotary elements and a protrusion on one end, said rotary elements of said worm gear are designed to engage said openings of said sliding mechanism of said second end of said movable jaw, at least a portion of said worm gear is designed to be situated within said channel of said tool head, said protrusion of said worm gear is designed to receive at least one transmitting gear; and
at least one adjustment gear and at least one transition gear, said adjustment gear is engaged with said transition gear, said transition gear is engaged with said transmitting gear which is engaged with said worm gear and which is further engaged with said sliding mechanism of said movable jaw, whereby the rotation of said adjustment gear creates movement of said movable jaw relative to said fixed jaw.

2. The tool of claim 1 wherein said second end of said elongated member comprises a handle.

3. The tool of claim 1 further comprises at least one cavity in said fixed jaw.

4. The tool of claim 3 further comprises at least one ratcheting cam, at least a portion of said ratcheting cam is situated within said cavity of said fixed jaw.

5. The tool of claim 1 further comprises at least one cavity situated within said movable jaw.

6. The tool of claim 5 further comprises at least one ratcheting cam, at least a portion of said ratcheting cam is situated within said cavity of said movable jaw.

7. The tool of claim 1 wherein each of said transmitting gear, said transition gear, and said adjustment gear comprises teeth.

8. The tool of claim 7 wherein said transmitting gear has at least four teeth.

9. The tool of claim 7 wherein said transition gear has at least four teeth.

10. The tool of claim 7 wherein said adjustable gear has at least four teeth.

11. The tool of claim 7 wherein there is a 2:1 ratio between the number of said teeth on said adjustment gear and the number of said teeth on said transmitting gear.

12. The tool of claim 7 where there is a ratio between the number of said of said teeth on said adjustment gear and the number of said teeth on said transmitting gear, said ratio is greater than a 1:1.

13. The tool of claim 1 further comprising a second compartment, at least a portion of said adjustment gear is situated within said first compartment, at least a portion of said transition gear is situated within said second compartment.

14. The tool of claim 1 wherein each of said adjustment and said transition gears comprise peripheral edges, each of said peripheral edges of said adjustment and said transition gears comprises teeth, said teeth of said adjustment gears and said teeth of said transition gear engage one another on the on same horizontal plane.

15. The tool of claim 1 wherein said adjustment gear comprises at least one surface, said adjustment gear comprise teeth situated on said surface, said transition comprises two opposing ends, each of said ends having a set of teeth, said teeth of said adjustment gear and a first set of said teeth of said transition gear engage one another on perpendicular planes.

16. The tool of claim 15 wherein said transmitting gear comprises teeth, said teeth of said transmitting gear and a second set of teeth of said transition gear engage one another on diagonal planes.

17. A tool comprising:
an elongated member having opposing ends, a first end comprises a tool head with a bolt engaging member and at least one channel, said bolt engaging member comprises at least one fixed jaw and at least one movable jaw, said movable jaw having two opposing ends, a first end of sad movable jaw having a contact surface for interacting with said fixed jaw and a second end of said movable jaw comprising a sliding mechanism with a plurality of openings;
at least one worm gear comprising a plurality of rotary elements and a protrusion on one end, said rotary elements of said worm gear are designed to engage said openings of said sliding mechanism of said second end of said movable jaw, at least a portion of said worm gear is designed to be situated within said channel of said tool head, said protrusion of said worm gear is designed to receive at least one transmitting gear; and
at least one adjustment gear situated within said tool head, said adjustment gear is engaged with said transmitting gear which is engaged with said worm gear which is further engaged with said sliding mechanism of said movable jaw, whereby rotation of said adjustment gear creates movement of said movable jaw relative to said fixed jaw.

18. The tool of claim 17 wherein said second end of said elongated member comprises a handle.

19. The tool of claim 17 further comprises at least one cavity in said fixed jaw.

20. The tool of claim 19 further comprises at least one ratcheting cam, at least a portion of said ratcheting cam is situated within said cavity of said fixed jaw.

21. The tool of claim 17 further comprises at least one cavity situated within said movable jaw.

22. The tool of claim 21 further at least one ratcheting cam, at least a portion of said ratcheting cam is situated within said cavity of said movable jaw.

23. The tool of claim 17 wherein each of said transmitting gear and said adjustment gear have a plurality of teeth.

24. The tool of claim 23 wherein said transmitting gear has at least four teeth.

25. The tool of claim 23 wherein said adjustable gear has at least four teeth.

26. The tool of claim 23 wherein there is a 2:1 ratio between the number of said teeth on said adjustment gear and the number of said teeth on said transmitting gear.

27. The tool of claim 23 where there is a ratio between the number of said of said teeth on said adjustment gear and the number of said teeth on said transmitting gear, said ratio is greater than a 1:1.

28. The tool of claim 23 wherein said adjustment gear comprises peripheral edges, said peripheral edges of said adjustment gear comprises teeth, said transmitting gear comprises a set of teeth, said teeth of said adjustment gear and said set of teeth of said transmitting gear engage one another on perpendicular planes.

29. A wrench apparatus comprising:
an elongated member having opposing ends, a first end comprises a tool head with a bolt engaging member, said bolt engaging member comprises at least one fixed jaw and at least one movable jaw, said moving jaw having two opposing ends, a first end having a contact surface for interacting with said fixed jaw and a second end comprising a sliding mechanism with a plurality of openings, said second end comprises a handle;
at least one worm gear comprising a plurality of rotary elements and a protrusion on one end, said rotary elements of said worm gear are designed to engage said openings of said sliding mechanism of said second end of said movable jaw, said protrusion of said worm gear is designed to receive at least one transmitting gear; and
at least one adjustment gear situated within said tool head, said adjustment gear is engaged with said transmitting gear which is engaged with said worm gear which is further engaged with said sliding mechanism of said movable jaw, whereby rotation of said adjustment gear creates movement of said movable jaw relative to said fixed jaw, wherein there is a 2:1 ratio between the number of said teeth on said adjustment gear and the number of said teeth on said transmitting gear.

30. The apparatus of claim 29 further comprises transition gear situated between said adjustment and transmitting gears.

31. The apparatus of claim 29 wherein said fixed jaw comprises at least one cavity for receiving a ratcheting device, said ratcheting device is selected from a group consisting essentially of cams, rollers, sliders, pins, protrusions and combinations thereof.

32. The apparatus of claim 29 wherein said movable jaw comprises at least one cavity for receiving a ratcheting device, said ratcheting device is selected from a group consisting essentially of cams, rollers, sliders, pins, protrusions and combinations thereof.
